(19) United States
(12) Patent Application Publication
(10) Pub. No.: US 2023/0198929 A1
(43) Pub. Date: Jun. 22, 2023

(54) ASYNCHRONIZED MESSAGE NOTIFICATION

(71) Applicant: Citrix Systems, Inc., Ft. Lauderdale, FL (US)

(72) Inventors: Ke Xu, Nanjing (CN); Shuai Ye, Nanjing (CN); Zongpeng Qiao, Nanjing (CN)

(73) Assignee: Citrix Systems, Inc., Ft. Lauderdale, FL (US)

(21) Appl. No.: 17/648,842

(22) Filed: Jan. 25, 2022

Related U.S. Application Data
(63) Continuation of application No. PCT/CN2021/138715, filed on Dec. 16, 2021.

(51) Int. Cl. H04L 51/00; H04L 51/043; G06F 40/30; H04L 67/55

(52) U.S. Cl. CPC H04L 51/14; H04L 51/12; H04L 51/043; G06F 40/30; H04L 67/26

(57) ABSTRACT

A method of pushing a message notification to a message recipient comprises capturing a message that is sent to a message recipient. The method further comprises extracting a first set of one or more message keywords from the message. The method further comprises extracting a second set of one or more recipient keywords from one or more digital resources associated with the message recipient. The method further comprises evaluating a correspondence between the first set and the second set. The method further comprises pushing, to the message recipient, at a notification time, a notification of the message. The notification time depends on the evaluated correspondence.

### CROSS-REFERENCE TO RELATED APPLICATION

This application is a continuation of International Application PCT/CN2021/138715 (filed 16 Dec. 2021), the entire disclosure of which is hereby incorporated by reference herein.

### BACKGROUND

Advances in computer and software technology have provided a wide range of tools that enhance collaboration amongst people who are distributed across a wide geographical area. One tool that has facilitated this collaboration is the digital workspace. A digital workspace delivers and manages software applications, data, and desktop working environments to collaborating users regardless of their physical location. Among other advantages, digital workspaces facilitate collaboration by providing a unified path for incoming message notifications received from the various software applications that collaborators use.

### SUMMARY

In at least one example, a method of pushing a message notification to a message recipient is provided. The method comprises capturing a message that is sent to a message recipient. The method further comprises extracting a first set of one or more message keywords from the message. The method further comprises extracting a second set of one or more recipient keywords from one or more digital resources associated with the message recipient. The method further comprises evaluating a correspondence between the first set and the second set. The method further comprises pushing, to the message recipient, at a notification time, a notification of the message. The notification time depends on the evaluated correspondence.

Examples of the method can incorporate one or more of the following features.

In the method, the correspondence is evaluated as a binary parameter that is selected from (a) a first value indicating that the message has greater than a threshold semantic similarity to the one or more digital resources, or (b) a second value indicating that the message has less than the threshold semantic similarity to the one or more digital resources.

In the method, the notification is pushed to the message recipient upon evaluating the correspondence as the first value.

In the method, the notification is pushed to the message recipient upon (a) evaluating the correspondence as the second value and (b) determining that the message recipient is in an idle state.

In the method, the notification is pushed to the message recipient upon (a) evaluating the correspondence as the second value and (b) determining that a maximum delay threshold has been reached.

In the method, evaluating the correspondence further comprises (a) generating a message vector representation of each of at least some of the one or more message keywords; (b) generating a recipient vector representation of each of at least some of the one or more recipient keywords; and (c) counting message vector representations that are similar to at least one of the recipient vector representations, wherein two vector representations are considered to be similar if they have a cosine similarity that exceeds a threshold.

In the method, the one or more digital resources associated with the message recipient are digital resources accessed by the message recipient in a time period before the message was sent to the message recipient.

In the method, the one or more digital resources associated with the message recipient are digital resources accessed by the message recipient within twenty-four hours of when the message was sent to the message recipient.

The method can further comprise (a) generating a first vector that represents a particular one of the message keywords; and (b) generating a second vector that represents a particular one of the recipient keywords; wherein evaluating the correspondence includes evaluating a similarity between the first and second vectors.

The method can further comprise receiving a message notification preference from a sender of the message, wherein the correspondence is evaluated in response to the message notification preference indicating that immediate notification of the message to the message recipient is optional.

In at least one example, a computer system is provided. The computer system comprises a memory and at least one processor coupled to the memory. The at least one processor is configured to capture a message that is sent to a message recipient. The at least one processor is further configured to extract a first set of one or more message keywords from the message. The at least one processor is further configured to extract a second set of one or more recipient keywords from one or more digital resources associated with the message recipient. The at least one processor is further configured to evaluate a correspondence between the first set and the second set. The at least one processor is further configured to, in response to making a first determination that the correspondence indicates that the message has greater than a threshold semantic similarity to the one or more digital resources, push a timely notification of the message to the message recipient. The at least one processor is further configured to, in response to making a second determination that the correspondence indicates that the message has less than the threshold semantic similarity to the one or more digital resources, push a delayed notification of the message to the message recipient.

Examples of the computer system can incorporate one or more of the following features.

In the computer system, the processor is further configured to, in response to making the second determination, (a) determine a minimum actions per time parameter APMₘᵢₙ associated with the message recipient during a first time period after the message recipient receives the message; (b) determine, at a time after the first time period has elapsed, a current actions per time parameter APM_{cur} for the message recipient; and (c) push the delayed notification to the message recipient in response to either (i) APM_{cur} being less than or equal to APMₘᵢₙ, or (ii) a maximum delay threshold being exceeded.

In the computer system, the processor is further configured to, in response to making the second determination, (a) make a third determination that (i) the message recipient has an inactive webcam, (ii) the message recipient has an inactive microphone, and (iii) the message recipient has not provided keyboard input during an input time threshold; and (c) push the delayed notification to the message recipient after making the third determination.

In the computer system, the processor is further configured to, in response to making the second determination, (a) make a third determination that the message recipient is in an idle state; and (b) push the delayed notification to the message recipient after making the third determination.

In the computer system, the processor is further configured to, in response to making the second determination, (a) make a third determination that a maximum delay threshold has been reached; and (b) push the delayed notification to the recipient after making the third determination.

In the computer system, the delayed notification indicates a time at which the message recipient received the message.

In at least one example, a non-transitory computer readable medium stores processor-executable instructions to push a message notification to a message recipient. The processor-executable instructions comprise instructions to determine, for a recipient of a message, a minimum actions per time parameter APMₘᵢₙ associated with the recipient during a first time period after the recipient receives the message. The processor-executable instructions comprise instructions to determine, at a time after the first time period has elapsed, a current actions per time parameter APM_{cur} for the recipient. The processor-executable instructions comprise instructions to push a notification of the message to the recipient in response to either (a) APM_{cur} being less than or equal to APMₘᵢₙ, or (b) a maximum delay threshold being exceeded, the maximum delay threshold being measured from when the recipient receives the message.

Examples of the non-transitory computer readable medium can incorporate one or more of the following features.

In the non-transitory computer readable medium, the maximum delay threshold is greater than or equal to two times the first time period.

In the non-transitory computer readable medium, the APMₘᵢₙ and APM_{cur} parameters are measured by counting how many actions the recipient takes per unit of time, wherein the actions include one or more of keyboard inputs and pointing inputs.

In the non-transitory computer readable medium, the processor-executable instructions further comprise instructions to determine that the recipient, during an entirety of the first time period, was performing at least one of (a) using a webcam; (b) using a microphone; or (c) using an input device without letting the input device remain idle for more than an input time threshold.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, each identical or nearly identical component that is illustrated is represented by a like reference numeral. For purposes of clarity, every component may not be labeled in every figure.

FIG. 1A is a timeline schematically illustrating example communication between a sender and a recipient, wherein the recipient fails to respond to a notification of an incoming message.

FIG. 1B is a timeline schematically illustrating example communication between a sender and a recipient, wherein a notification of an incoming message causes the recipient to incur distracted time.

FIG. 1C is a timeline schematically illustrating example communication between a sender and a recipient, wherein the recipient is promptly notified of an incoming message that is relevant to his/her current activity, but wherein notification of other messages is delayed.

FIG. 2 is a block diagram schematically illustrating selected components of an example framework for manipulating delivery of message notifications based on a recipient's activity at the time a message is received.

FIGS. 3A-3B comprise a flowchart illustrating an example method for manipulating delivery of message notifications based on a recipient's activity.

FIG. 4 illustrates an example message composition user interface that allows a sender to select automatic or instant message notification.

FIG. 5 is a flowchart illustrating an example method for extracting keywords and evaluating correlation between message content and a recipient's current activity.

FIG. 6 is a flowchart illustrating an example method for determining when a message notification should be pushed to a recipient.

FIG. 7 is a line graph illustrating an example recipient's actions per unit time (APM) as a function of time, wherein an initial stage threshold T₃ is 30 minutes.

FIG. 8A illustrates an example instant push notification user interface.

FIG. 8B illustrates an example delayed push notification user interface.

FIG. 9 is a block diagram schematically illustrating an example computing device configured to implement various components of the systems disclosed herein.

### DETAILED DESCRIPTION

As noted above, one way that a digital workspace facilitates collaboration is by providing a unified path and notification host for messages that are received from the various software applications managed by the digital workspace. A digital workspace can be used to access a wide range of software applications, many of which may provide their own communication and notification services. Examples of software applications that provide notification services include email clients (for instance, as may be provided by Microsoft Outlook or Mozilla Thunderbird), instant messaging services (for instance, as may be provided by Google Hangouts or Microsoft Teams), and project management software applications (for instance, as may be provided by Slack or Jira). The messaging services provided by software applications such as these have grown so ubiquitous that many users prefer to use such services instead of face-to-face or telephone communication. A digital workspace can provide a unified notification center where a user can view notifications received from software applications such as these. This allows a collaborator to view, record, track, and manage all of his/her notifications in single location.

While a digital workspace notification center provides advantages with respect to the organization of a user's notifications, the fact remains that an incoming notification can still interrupt a user's immediate task at hand. In general, as digital workspaces become more ubiquitous and integrated with larger numbers of applications, and as the number of software applications that provide customized notifications increases, the frequency and variety of these incoming notifications will likely increase as well. People necessarily have a finite attention span, and for a user who is fully engaged in intense work, or who is attempting to actively engage with others via videoconference, being interrupted with notifications of messages that do not require immediate attention can be an overwhelming burden. If the recipient is engaged in screen sharing, incoming notifications that are unrelated to the task at hand raise the risk of exposing sensitive information to unintended recipients. And even if the user mutes or otherwise ignores unwanted notifications, the risk of ultimately forgetting to reply still lingers in the background.

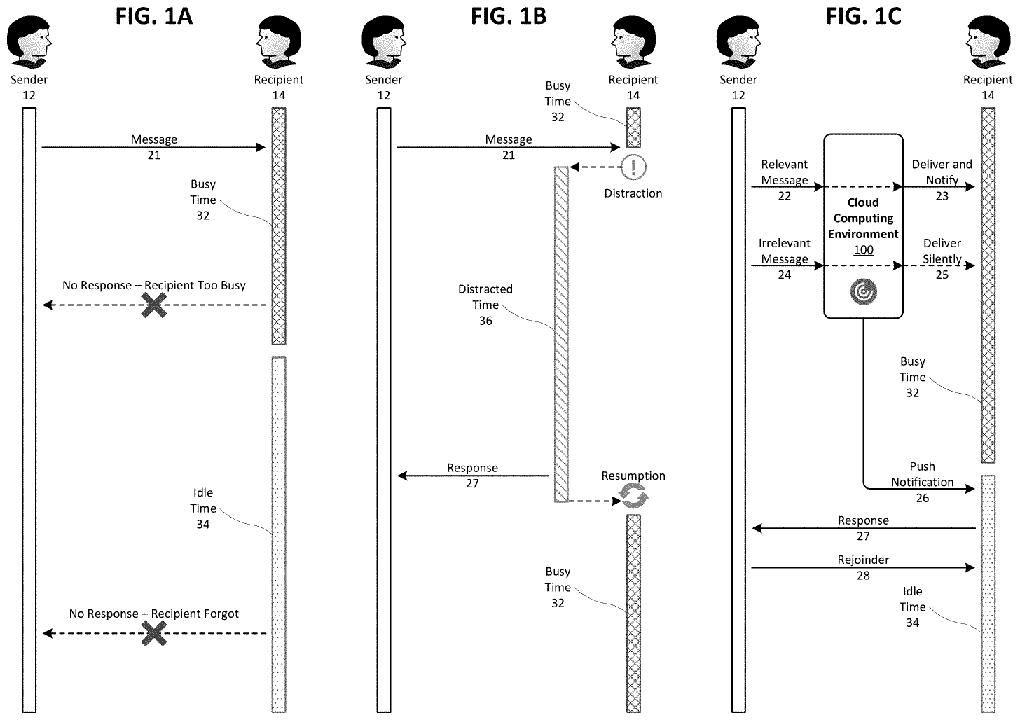

The burden associated with these interruptions can manifest in a number of ways. For example, FIG. 1A is a timeline schematically illustrating example communication between a sender 12 and a recipient 14, wherein recipient 14 fails to respond to a notification of an incoming message 21. In particular, the notification of incoming message 21 has interrupted the recipient's busy time 32 during which recipient 14 is focused on a task that is unrelated to the incoming message 21. Because message 21 is unrelated to the recipient's immediate task at hand, he/she neglects to respond to message 21. By the time the recipient's busy time 32 has transitioned to idle time 34, recipient 14 has forgotten about message 21, and forgets to respond to sender 12. The result is that recipient 14 never responds to sender 12, who must either follow up with recipient 14 or resend message 21 later. At best, a loss in productivity and delayed response occurs, with more serious consequences of the missed communication resulting depending on the message content.

To provide another example, FIG. 1B is a timeline schematically illustrating example communication between sender 12 and recipient 14, wherein a notification of incoming message 21 causes recipient 14 to incur distracted time 36. As with the prior example, the notification of the incoming message 21 has interrupted the recipient's busy time 32 during which he/she had been focused on a task unrelated to the incoming message 21. But in this case, recipient 14 takes the time to send a response 27 to the incoming message 21. The time that recipient 14 spends responding to message 21 can be considered distracted time 36. Even if recipient 14 is able to eventually resume his/her prior task after sending response 27, the interruption nevertheless results in a loss in productivity as compared to if recipient 14 were able to respond to message 21 after his/her immediate task at hand were complete.

While some software tools allow incoming notifications to be muted or delivered silently, the fact remains that some notifications may be relevant to the recipient's immediate task at hand and should be delivered immediately. Other notifications are less urgent and can be delayed, delivered silently, or otherwise presented in a way that is less likely to interrupt the recipient's immediate task at hand. Thus many users wish to mitigate the burden associated with incoming notifications without missing messages that call for immediate attention. Ideally, the message recipient 14 would be able to selectively mute notifications associated with messages that are not related to the recipient's immediate task at hand, at least for a specified period of time.

To address these competing interests, disclosed herein is a framework for manipulating delivery of message notifications based on a recipient's activity at the time a message is received. In particular, FIG. 1C is a timeline schematically illustrating example communication between sender 12 and recipient 14, wherein recipient 14 is promptly notified of an incoming message 22 that is relevant to his/her current activity, but wherein notification of other messages 24 is delayed. In this example, a cloud computing environment 100 receives both relevant messages 22 and other messages 24 from one or more senders 12. Other messages 24 may also be referred to as irrelevant messages. In this context, the terms “relevant” and “irrelevant” are used to describe the relationship between the content of a message and the recipient's current activity when the message is received. If recipient 14 should be notified immediately of an incoming message, that message would be considered “relevant”. On the other hand, if notifying recipient 14 of the incoming message would interrupt recipient's busy time 32 and thus cause recipient to incur distracted time 36, that message would be considered “irrelevant”.

While cloud computing environment 100 can be configured to deliver all messages without delay, cloud computing environment 100 will only generate a notification 23 for relevant message 22. Other messages will be delivered with only a silent notification 25. Thus cloud computing environment 100 does not affect message transmission provided by the underlying communication software (for example, as provided by Microsoft Outlook, Google Hangouts, or Slack), but instead only manipulates the message notification activity. For messages that are delivered silently, a push notification 26 can be sent to recipient 14 later, for example, when recipient 14 is detected to have idle time 34, when recipient 14 is no longer occupied with busy time 32, or when a maximum delay is reached. This allows further communication between sender 12 and recipient 14, for example response 27 and rejoinder 28, to occur when such communication is less likely to cause recipient 14 to incur substantial productivity loss.

The framework illustrated in FIG. 1C mitigates interruptions to recipient's busy time 32, allowing him/her to focus on immediate tasks at hand. But because message notifications are generated based on a substantive evaluation of the recipient's current activity, notifications which are relevant to that current activity are presented without delay, thus decreasing the likelihood that recipient 14 will miss important communications. In certain implementations this substantive evaluation includes a semantic analysis of both the incoming message and the recipient's current activity. The substantive evaluation may also consider the nature of recipient's current activity, such as whether recipient 14 is actively using a webcam, microphone, keyboard, and/or mouse. The result is a more refined and intelligent notification system as compared to existing techniques that either generate immediate notifications for all incoming messages or suppress all notifications during a specified time period.

The framework illustrated in FIG. 1C also provides advantages to a message sender 12. In particular, from the sender's perspective, it is impolite to interrupt the recipient's current activity with a message that, while important, does not require recipient 14 to respond right away. While some software applications provide an option for delayed or scheduled delivery, it is impossible for sender 12 to know the recipient's status at the scheduled delivery time. On the other hand, by decreasing the likelihood that a less relevant message interrupts the recipient's current activity, sender 12 can, at the same time, increase the likelihood that a message that is relevant to the recipient's current activity receives prompt attention, including any appropriate response 27. Moreover, sending a message that causes a notification to be displayed on the recipient's screen risks exposing sensitive information to unintended recipients if recipient 14 happens to be sharing his/her screen when the message is sent.

### Improved Framework for Asynchronized Message Notification—Architecture

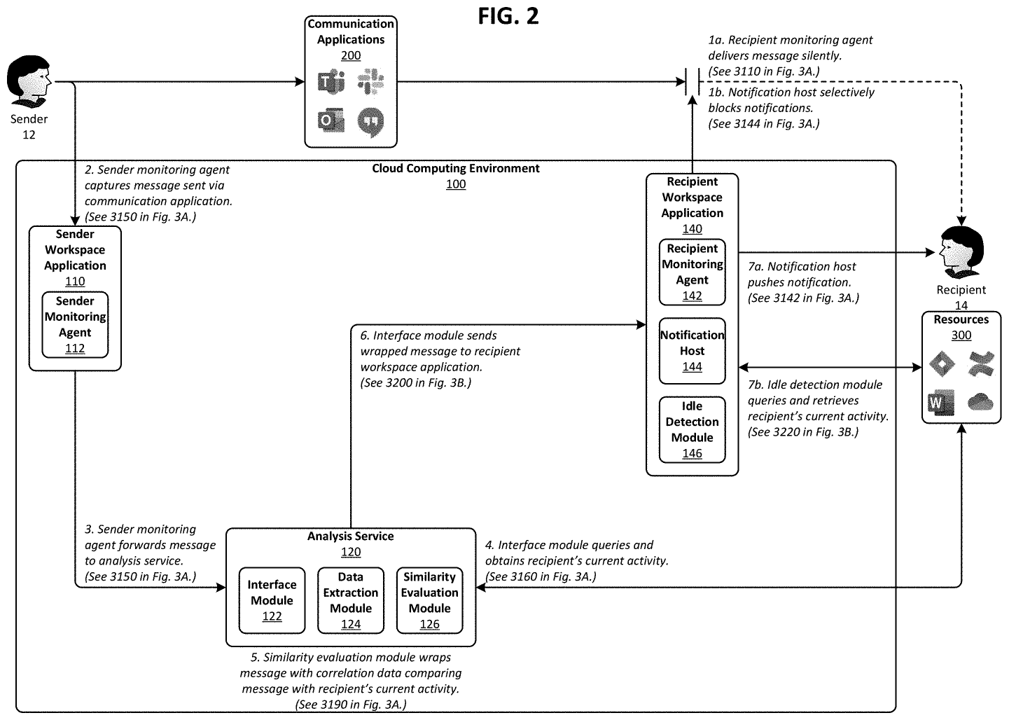

FIG. 2 is a block diagram schematically illustrating selected components of an example framework for manipulating delivery of message notifications based on a recipient's activity at the time a message is received. FIG. 2 illustrates message sender 12 who uses one or more communication applications 200 to send a message to message recipient 14. At the time the message is received, recipient 14 is engaged with a task at hand using one or more resources 300. The task at hand may or may not be related to the content of the message received from sender 12. Both sender 12 and recipient 14 leverage services provided by cloud computing environment 100, including message notification services.

The communications that occur between sender 12, recipient 14, cloud computing environment 100, communication applications 200, and resources 300 occur via one or more communication networks. When multiple networks are used, the various networks can be of the same type or different type. For example, in some embodiments the one or more networks are a private network such as a local area network or a corporate intranet; a public network such as a metropolitan area network or a wide area network; or the Internet. Each of the one or more networks can employ one or more types of physical networks and/or network topologies, such as wired and/or wireless networks, and can employ one or more communication transport protocols, such as transmission control protocol, internet protocol, user datagram protocol, or other similar protocols. In some embodiments, each of the one or more networks include one or more mobile telephone networks that use various protocols to communicate amongst mobile devices. In some embodiments, each of the one or more networks include one or more wireless local area networks (WLANs). Short range communication within a WLAN can be achieved using 802.11, Bluetooth, and/or near field communication.

Cloud computing environment 100 delivers shared computing services and/or resources to multiple users, including sender 12 and recipient 14. The shared resources and services can include, but are not limited to, networks, network bandwidth, servers, processing, memory, storage, applications, virtual machines, databases, software, hardware, analytics, intelligence, and message notification services. Cloud computing environment 100 may encompass backend platforms such as servers, storage resources, server farms, and/or data centers. In one example implementation, cloud computing environment 100 provides a private cloud serving a single organization (for example, an enterprise cloud), while in another example implementation cloud computing environment 100 provides a community or public cloud serving multiple organizations. In general, servers providing the underlying functionality associated with cloud computing environment 100 can be located in distributed geographical locations.

In certain implementations cloud computing environment 100 provides resource pooling to serve multiple users through a multitenant model with different physical and virtual resources dynamically assigned and reassigned responsive to different user demands. The multitenant model can include a system or architecture that provides a single instance of software that serves multiple users. In some embodiments, cloud computing environment 100 provides on-demand self-service to unilaterally provision computing capabilities (for example, server time or network storage) across a network for multiple users. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 100 can provide an elasticity that scales in response to different demands from one or more clients. In some embodiments, cloud computing environment 100 provides monitoring services to monitor, control, and/or generate reports corresponding to the provided shared services and resources.

In some implementations, cloud computing environment 100 provides cloud-based delivery of different types of cloud computing services, such as software as a service (SaaS), platform as a service (PaaS), infrastructure as a service (IaaS), and desktop as a service (DaaS). IaaS refers, for example, to a user renting the use of infrastructure resources that are needed during a specified time period. IaaS providers may offer storage, networking, servers, or virtualization resources from large pools, allowing users to quickly scale up by accessing more resources as needed. Examples of IaaS include Amazon Web Services, Rackspace Cloud, Google Compute Engine, and RightScale.

PaaS providers offer functionality provided by IaaS, including, for example, storage, networking, servers, or virtualization, as well as additional resources such as, for example, the operating system, middleware, or runtime resources. Examples of PaaS include Windows Azure, Google App Engine, and Heroku.

SaaS providers offer resources similar to those offered by PaaS providers, including storage, networking, servers, virtualization, operating system, middleware, or runtime resources. In some cases, SaaS providers may offer additional resources including, for example, data and application resources. Examples of SaaS include Google Apps, Salesforce, and Office 365. Examples of SaaS also include data storage providers such as Citrix ShareFile, Dropbox, Microsoft OneDrive, Google Drive, and Apple iCloud.

DaaS, which is also known as hosted desktop services, is a form of virtual desktop infrastructure in which virtual desktop sessions are typically delivered as a cloud service along with the applications used on the virtual desktop. Citrix Cloud is one example of a DaaS delivery platform. DaaS delivery platforms may be hosted on a public cloud computing infrastructure such as Azure Cloud or Amazon Web Services. In the case of Citrix Cloud, the Citrix Workspace application can be used as a single-entry point for bringing applications, files, and desktops together, either on-premises or in the cloud, to deliver a unified experience.

One or more resource management services can be used to manage and streamline user access to one or more resource feeds via one or more gateway services and/or one or more SaaS applications. A resource management service optionally employs an identity provider to authenticate the user and, following authentication, identify one of more resources the user is authorized to access. In response to the user selecting one of the identified resources, the resource management service sends appropriate access credentials to the requesting user. The requesting user can then use those credentials to access the selected resource. The one or more resource feeds can include systems or services for providing virtual applications and/or desktops to users, one or more file repositories and/or file sharing systems, one or more secure browser services, one or more access control services for SaaS applications, one or more management services for local applications executing on user computers, one or more Internet enabled devices or sensors, and the like.

Examples of the services provided by a cloud-based resource management service include a client interface service, an identity service, a resource feed service, and a single sign-on service. A resource access application can be used to communicate with the client interface service as well as to present a user interface that a user can operate to access resource feeds and/or SaaS applications. A resource application can be installed on the user's computer, or can be executed by the client interface service within cloud computing environment 100 and accessed by, for example, a web browser executing on the user's computer. In general, the resource access application can be understood as providing the user with a personalized, all-in-one interface that enables instant and seamless access to the user's SaaS applications, web applications, files, virtual Windows applications, virtual Linux applications, desktops, mobile applications, Citrix Virtual Apps and Desktops, local applications, file repositories, file sharing systems, and other data. Resource access application can also be understood as providing access to communication applications 200.

Event notifications in a resource activity feed may be accompanied by a discrete set of user-interface elements—for example, “approve”, “deny”, and “see more detail” buttons—that allow a user to take one or more simple actions with respect to each event right within the user's feed. In some embodiments, such a streamlined, intelligent resource activity feed may be enabled by one or more “microapps” that can interface with underlying associated resources using application programming interfaces (APIs) or the like. The responsive actions may be user-initiated activities that are taken within the microapps and that provide inputs to the underlying applications through the API or other interface. The actions a user performs within the microapp may, for example, be designed to address specific common problems and use cases quickly and easily (for example, request personal time off, submit a help desk ticket, and the like), thus adding to increased user productivity. Notifications from such event-driven microapps may additionally or alternatively be pushed to users to provide notification of something that requires the user's attention, such as approval of an expense report, availability of a new course for registration, and the like. The various techniques disclosed herein for manipulating how notifications are pushed to recipient 14 can likewise be applied to notifications generated by event-driven microapps or other notification services hosted by cloud computing environment 100.

A notification service can process and store notifications received from a user's digital resources, and can also store notifications in a database to be later served in an activity feed. The notification service can additionally or alternatively send notifications out immediately to a user as a push notification. The various techniques disclosed herein can be used to determine whether a particular notification should be pushed to recipient 14 immediately or deferred. Furthermore, while the various techniques disclosed herein can be applied to message notifications, it will be appreciated that in alternative embodiments such techniques can be applied to a wide variety of different notifications generated by resources administered by cloud computing environment 100. As used herein, the term “push” encompasses functionality that causes a notification to be provided or otherwise delivered to a message recipient 14, such as by causing a notification to be sent to and presented at one or more computing devices associated with recipient 14. The presentation can be made visually, aurally, haptically, or using any other suitable technique to draw the recipient's attention to the notification.

### Improved Framework for Asynchronized Message Notification—Functionality

As noted above, FIG. 2 is a block diagram schematically illustrating selected components of an example framework for manipulating delivery of message notifications based on a recipient's activity at the time a message is received. As described above, sender 12 and recipient 14 use cloud computing environment 100 to access digital resources, including resources provided by one or more communication applications 200. Example communication applications include Microsoft Teams, Microsoft Outlook, Slack, and Google Hangouts. Sender 12 accesses resources associated with cloud computing environment 100 using a sender workspace application 110, while recipient 14 access resources associated with client computing environment 100 using a recipient workspace application 140. In one implementation sender workspace application 110 and recipient workspace application 140 each provide functionality associated with a resource management service, as described above.

Sender 12 invokes one or more communication applications 200 to send a message to recipient 14. Sender workspace application 110 includes a sender monitoring agent 112 that is configured to interface with, and provide supplemental functionality to, communication applications 200. In certain implementations sender monitoring agent 112 is invoked in response to sender 12 accessing his/her digital workspace via cloud computing environment 100. Sender monitoring agent 112 can be verified using client credentials via a “RESTful” API that obeys representational state transfer (REST) constraints. In an example implementation, sender monitoring agent 112 provides sender 12 with the option to send his/her message with “instant notification” or “automatic notification”. If sender 12 chooses instant notification, recipient 14 will be notified of the sender's message upon receipt. On the other hand, if sender 12 elects “automatic notification”, recipient workspace application 140 will attempt to determine the degree to which the incoming message relates to recipient's current activity and will manipulate the message notification accordingly. Providing sender 12 with the option of selecting instant or automatic notification allows the framework illustrated in FIG. 2 to coexist with workspace instant messaging applications so that urgent communications can still be pushed at any time.

Recipient workspace application 140 similarly includes a recipient monitoring agent 142 that is also configured to interface with, and provide supplemental functionality to, communication applications 200. Recipient monitoring agent 142 is likewise invoked in response to recipient 14 accessing his/her digital workspace via cloud computing environment 100. Recipient monitoring agent 142 can also be verified using client credentials via a RESTful API. In an example implementation, and as illustrated in FIG. 2 operation 1a, recipient monitoring agent 142 delivers the message to recipient 14 silently. But as illustrated in FIG. 2 operation 1b, recipient workspace application 140 also includes a notification host 144 that selectively blocks certain notifications generated by communication applications 200. More specifically, in certain embodiments notification host 144 blocks push notifications generated by communication applications 200 via a respective API, and replaces the blocked notifications with one or more of its own customized notifications as desired. Thus notification agent 144 can be configured to block immediate notification of messages sent with “automatic notification” while allowing notification of messages sent with “instant notification”. In short, while notification agent 144 manipulates message notification of certain messages, it does not interfere with message delivery from communication applications 200 to recipient 14. For example, in certain implementations delayed notifications are made available to recipient 14 in a message center administered by recipient workspace application 140, thus allowing recipient 14 to access such messages if he/she takes the initiative to do so. A delayed notification optionally indicates the time at which the corresponding message was actually received by recipient 14.

As illustrated in FIG. 2 operation 2, sender monitoring agent 112, on the other hand, can be configured to capture messages sent using communication application 200. And as illustrated in FIG. 2 operation 3, sender monitoring agent 112 also forwards a copy of the captured message to an analysis service 120 administered by cloud computing environment 100. In general, analysis service 120 is configured to analyze message content and determine the extent to which a message is semantically related to current activity of message recipient 14. At any arbitrary time, including at the time the message is sent, recipient 14 can be understood as either being idle or engaged with a task at hand using one or more resources 300. As used herein, the recipient's “current activity” or “task at hand” refers to activity of the recipient during a particular timeframe leading up to the point at which the message is received. This particular timeframe can be, for example, one hour, two hours, four hours, six hours, eight hours, ten hours, twelve hours, eighteen hours, twenty-four hours, or any other suitable timeframe. Thus, as illustrated in FIG. 2 operation 4, analysis agent 120 includes an interface module 122 that is configured to query resources 300 to obtain data that characterizes the recipient's current activity. This can be accomplished using the recipient's authentication credentials which are accessible via the recipient's account with cloud computing environment 100. Optionally, certain implementations are configured such that recipient 14 is required to grant cloud computing environment 100—and thus interface module 122—access to his/her resources 300 to acquire the relevant data.

Analysis service 120 further includes a data extraction module 124 configured to extract keywords from the sender's captured message as well as from the data that characterizes the recipient's current activity. Analysis service 120 also further includes a similarity evaluation module 126 configured to make a determination with respect to whether the message semantically relates to the recipient's current activity. Specific techniques for making this evaluation will be described in turn. In one implementation, this evaluation results in a binary label, for example yes/no, that indicates whether sufficient correlation has been established. In this context, “sufficient” correlation refers to a degree of similarity that is deemed sufficient such that recipient 14 should be notified of the incoming message without delay. As illustrated in FIG. 2 operation 5, similarity evaluation module 126 can be configured to wrap or otherwise supplement the message with correlation data comparing the message to the recipient's current activity. As noted above, in certain implementations this correlation data may comprise a binary indicator.

As illustrated in FIG. 2 operation 6, interface module 122 sends the wrapped message to recipient workspace application 140. As illustrated in FIG. 2 operation 7a, where the correlation data indicates that the wrapped message is semantically related to the recipient's current activity, notification host 144 can be configured to push notification of the incoming message to recipient 14. On the other hand, as illustrated in FIG. 2 operation 7b, where the correlation data indicates that the wrapped message is not semantically related to the recipient's current activity, an idle detection module 146 can be configured to query and retrieve data characterizing the recipient's current activity. For example, such data can characterize how recipient 14 is interacting with resources 300, including for example, whether recipient 14 is actively using a webcam, microphone, keyboard, and/or mouse. If recipient 14 is judged to be actively engaged with resources 300, delivery of the message can be delayed, at least until a maximum delay threshold is reached. On the other hand, notification host 144 can be configured to push notification of the incoming message to recipient 14 in response to idle detection module 146 determining that recipient 14 is no longer actively engaged with resources 300, and thus idle. Additional details with respect to determining whether recipient is idle will be provided in turn. But in any case, this configuration is based on the assumption that it is acceptable, or even preferable, for users to receive messages when they are relatively idle, such as when they step away from their workstation for a cup of coffee. Messages delivered at this time are less likely to interrupt the recipient's current task at hand.

### Methodology

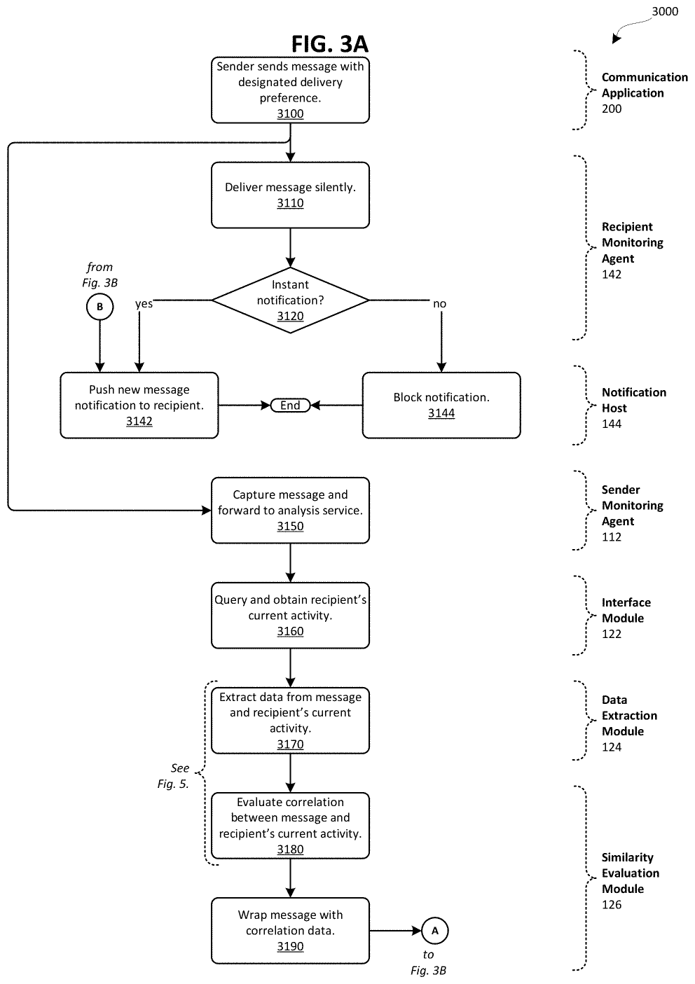

FIGS. 3A-3B comprise a flowchart illustrating an example method 3000 for manipulating delivery of message notifications based on a recipient's activity. Method 3000 can be implemented, for example, using the framework illustrated in FIG. 2 and described herein, and in particular, using functionality provided by various components of cloud computing environment 100 and communication applications 200. However other system architectures can be used in other implementations. To this end, the correlation of the various functionalities shown in FIGS. 3A-3B to the various components of cloud computing environment 100 and communication applications 200, and their various subcomponents, is not intended to imply any structural and/or use limitations. Rather, other implementations may include, for example, varying degrees of integration wherein certain functionalities are effectively performed by different systems or modules. For example, in an alternative implementation, functionality illustrated as being provided by communication applications 200 may instead be provided by a resource management service within cloud computing environment 100. Thus other implementations may have fewer or more modules depending on the granularity of a particular implementation. As can be seen, method 3000 includes a number of phases and subprocesses, the sequence of which may vary from one implementation to another. However, when considered in the aggregate, these phases and subprocess are capable of manipulating delivery of message notifications based on a recipient's activity when a message is received.

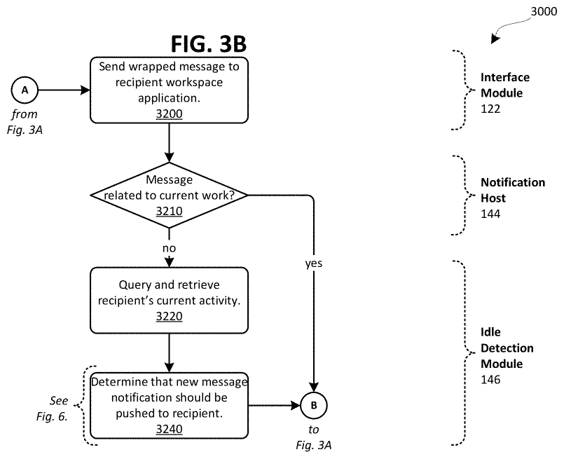

In one implementation, method 3000 starts when sender 12 invokes one or more of communication applications 200 to send a message. See reference numeral 3100 in FIG. 3A. In an example implementation, sender monitoring agent 112 provides sender 12 with the option to send his/her message with “instant notification” or “automatic notification”. FIG. 4 illustrates an example message composition user interface 4000 that allows a sender to select automatic or instant message notification. Message composition user interface 4000 includes a data entry field 4100 where sender 12 can input the message to be sent. User interface 4000 further includes a user interface element that allows sender 12 to choose between instant notification 4200 and automatic notification 4300. Providing sender 12 with the option of selecting instant or automatic notification allows the framework illustrated in FIG. 2 to coexist with workspace instant messaging applications so that urgent communications can still be pushed at any time. In an alternative implementation the message delivery option can be provisioned by an administrator instead of by sender 12.

Recipient monitoring agent 142 can be configured to deliver the message silently. See reference numeral 3110 in FIG. 3A and operation 1a in FIG. 2. Recipient monitoring agent 142 can also be configured to make a determination with respect to whether the message is to be delivered to recipient 14 as soon as possible, or with a possible delay based on the recipient's current activity. See reference numeral 3210 in FIG. 3A. This determination can be made based on, for example, the notification preference that sender 12 indicated using the example message composition user interface 4000 illustrated in FIG. 4. If the message was sent with instant notification, notification host 144 is configured to push the new message notification to recipient 14. See reference numeral 3142 in FIG. 3A. On the other hand, if the message was sent with automatic notification, notification host 144 is configured to block any notification generated by communication applications 200. See reference number 3144 in FIG. 3A and operation 1b in FIG. 2. Because the message itself is delivered to recipient 14 regardless of the sender's notification preference, silent notifications are optionally made available to recipient 14 in a message center administered by recipient workspace application 140, thus allowing recipient 14 to access such messages if he/she takes the initiative to do so.

In addition to the aforementioned processing that occurs at recipient workspace application 140, further processing is carried out by sender workspace application 110. In particular, sender monitoring agent 112 captures the message and forwards it to analysis service 120. See reference numeral 3150 in FIG. 3A and operations 2 and 3 in FIG. 2. At a high level, analysis service 120 is configured to make a determination with respect to whether the sender's message is semantically related to the recipient's current activity. This determination is a consideration when determining whether recipient 14 should be interrupted with a notification of the received message. In an example implementation, analysis service 120 is integrated into, and is administered by, cloud computing environment 100.

At any arbitrary time, including at the time the message is sent, recipient 14 can be understood as either being idle or engaged with a task at hand using one or more resources 300. The resources that recipient 14 accesses as he/she works can provide insight into the substance of the recipient's activity. Analysis service 120 therefore includes interface module 122, which is configured to query resources 300, and/or the recipient's workflows that exchange data with resources 300, to obtain data that characterizes the recipient's current activity. See reference numeral 3160 in FIG. 3A and operation 4 in FIG. 2. This can be accomplished using the recipient's authentication credentials which are accessible via the recipient's account with cloud computing environment 100. In one implementation, data is harvested from one or more workflows associated with recipient 14 over a designated timeframe, such as thirty minutes, one hour, two hours, four hours, six hours, eight hours, ten hours, twelve hours, eighteen hours, twenty-four hours, or any other suitable timeframe. In certain embodiments the timeframe is a period before which an incoming message was received, for example, in the previous hour, twelve hours, or twenty-four hours before the incoming message was received. The recipient's workflow data can be collected from resources 300 via a RESTful API provided by recipient workspace application 140 and/or analysis service 120. The workflow data will include data extracted from resources that recipient 14 accesses during the designated timeframe, such as documents, customer support tickets, webpages, network addresses, data associated with messaging tools, data associated with collaboration tools, and any other local or networked digital resources.

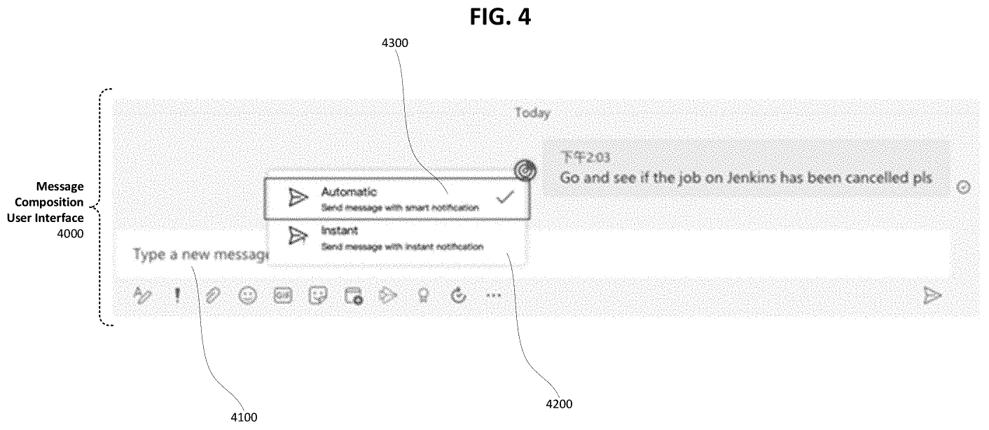

Analysis service 120 includes data extraction module 124 which is configured to extract keywords from both the sender's captured message as well as the aforementioned data that characterizes the recipient's current activity. See reference numeral 3170 in FIG. 3A. Analysis service 120 also includes similarity evaluation module 126 which uses the extracted data to make a determination with respect to whether the message semantically relates to the recipient's current activity. See reference numeral 3180 in FIG. 3A. FIG. 5 is a flowchart illustrating an example method 5000 for extracting keywords and evaluating correlation between message content and a recipient's current activity using data extraction module 124 and similarity evaluation module 126. In one implementation, method 5000 can be understood as providing a semantic machine learning algorithm to evaluate the correlation, if any, between the message content and the recipient's current activity.

Turning now to FIG. 5, method 5000 starts after analysis service 120 has acquired both the sender's message (referred to herein as message data 12) and data characterizing the recipient's current activity (referred to herein as recipient data 22). At a high level, method 5000 attempts to evaluate semantic correlation between message data 12 and recipient data 22 by counting identical or similar keywords. To this end, data extraction module 124 is configured to extract keywords from message data 12 and recipient data 22, thus resulting in a set of message keywords 14 (denoted as Gₘ) and a set of recipient keywords 24 (denoted as Gᵣ). See reference numeral 5100 in FIG. 5. In one implementation, a machine learning topic model is used to classify words included in message data 12 and recipient data 22 into a number of topics K. The K topics can be established based on a historical data set or a pre-established training data set, although if the message data 12 and recipient data 22 are sufficiently large, the machine learning topic model itself can be used to identify the K topics. In one implementation the machine learning topic model is the latent Dirichlet allocation (LDA) model.

Applying the machine learning topic model to message data 12 results in the words included in message data 12 being distributed across the K topics, with a message score being generated for each topic. A higher message score for a given topic indicates that the given topic is, from a semantic standpoint, more closely related to message data 12. The topics with the highest message scores can be selected as being representative of message data 12. This set of topics with the highest message scores is referred to herein as the set of message keywords Gₘ 14. In one implementation the set Gₘ includes nₘ message keywords, wherein nₘ is an integer greater than one.

Likewise, applying the machine learning topic model to recipient data 22 results in the words included in recipient data 22 being distributed across the K topics, with a recipient score being generated for each topic. Again, a higher recipient score for a given topic indicates that the given topic is, from a semantic standpoint, more closely related to recipient data 22. The topics with the highest recipient scores can be selected as being representative of recipient data 22. This set of topics with the highest recipient scores is referred to herein as the set of recipient keywords Gᵣ 24. In one implementation the set Gᵣ includes nᵣ recipient keywords, wherein nᵣ is an integer greater than one.

Once the set of message keywords Gₘ 14 and the set of recipient keywords Gᵣ 24 have been generated, the similarity between these keyword sets can be evaluated. To facilitate this comparison, data extraction module 124 is further configured to vectorize each of the nₘ message keywords in Gₘ and to also vectorize each of the nᵣ recipient keywords in Gᵣ. See reference numeral 5110 in FIG. 5. In one implementation, a pretrained neural network model is used to generate a m-dimension vector for each keyword in Gₘ and Gᵣ. For example, in an implementation where there are nₘ message keywords in Gₘ, a corresponding nₘ word vectors 16 will be generated, and where there are nᵣ recipient keywords in Gᵣ, a corresponding nᵣ word vectors 26 will be generated.

The neural network model is pretrained to learn word associations from a large training corpus and, once trained, is capable of representing individual words with a particular list of numbers that form a vector. These vectors, referred to herein as word vectors, allow a mathematical function, such as cosine similarity, to be used to evaluate similarity between two words represented by their respective two vectors. In one specific implementation the Word2vec technique is used to generate m-dimension word vectors for each keyword in Gₘ and Gᵣ. In one specific implementation m=300, although other dimension vectors can be used in other embodiments. Thus the result of the aforementioned vectorization is a first set of nₘ word vectors 16 representing the message, and a second set of nᵣ word vectors 26 representing the recipient's current activity.

Similarity evaluation module 126 is configured to compare each of the nₘ word vectors 16 with each of the nᵣ word vectors 26. In one implementation this is accomplished by evaluating the cosine similarity between one of the nₘ word vectors associated with the message and one of the nᵣ word vectors associated with the recipient's activity. See reference numeral 5120 in FIG. 5. Other similarity measures can be evaluated in other implementations. It is then determined whether the evaluated similarity is greater than or equal to an established similarity threshold T₁. See reference numeral 5140 in FIG. 5. If so, a similarity count associated with the message is incremented. See reference numeral 5142 in FIG. 5. If not, it is then determined whether all vector combinations amongst the nₘ word vectors and the nᵣ word vectors have been evaluated. See reference numeral 5150 in FIG. 5. In one implementation nₘ×nᵣ vector combinations will be evaluated. In an alternative implementation only a subset of the nₘ×nᵣ possible vector combinations are evaluated. In one implementation the similarity threshold T₁=0.90, although other values for T₁ can be used in other implementations, such as T₁=0.95, T₁=0.80, T₁=0.75, T₁=0.50, T₁=0.40, or T₁ equals any other suitable value. The similarity threshold T₁ can be adjustable by one or more of an administrator, message sender 12, or message recipient 14. In other implementations the similarity threshold T₁ is hardcoded and/or provisioned by default.

After an established portion (for example, 100%, 80%, 75%, 50% or other portion) of the nₘ×nᵣ possible vector combinations are evaluated, similarity evaluation module 126 is further configured to determine whether the similarity count associated with the message is greater than or equal to a similarity count threshold T₂. See reference numeral 5160 in FIG. 5. The similarity count threshold T₅ represents a threshold quantity of similar keywords above which the message should be considered as being semantically related to the recipient's current activity. In one implementation the similarity count threshold T₂=6, although other values for T₂ can be used in other implementations, such as T₂=2, T₂=3, T₂=4, T₂=5, T₂=8, T₂=10, T₂=12, T₂=15, T₂=20, or T₂ equals any other suitable value. The similarity count threshold T₂ can be adjustable by one or more of an administrator, message sender 12, or message recipient 14. In other implementations the similarity threshold T₂ is hardcoded and/or provisioned by default.

If the similarity count associated with the message is greater than or equal to similarity count threshold T₂, the message can be considered to be related to the recipient's current activity. See reference numeral 5162 in FIG. 5. On the other hand, if the similarity count associated with the message is not greater than or equal to similarity count threshold T₂, the message can be considered to be unrelated to the recipient's current activity. See reference numeral 5164 in FIG. 5. In either event, similarity evaluation module 126 can be configured to generate correlation data that indicates whether sufficient similarity has been established between the message and the recipient's current activity. In one implementation the correlation data is a binary label, for example yes/no, that indicates whether sufficient similarity has been established. Similarity evaluation module 126 can be configured to wrap or otherwise supplement the message with the correlation data. See reference numeral 3190 in FIG. 3A and operation 5 in FIG. 2.

In certain embodiments, once the correlation data has been generated, interface module 122 sends the message and the correlation data to recipient workspace application 140. See reference numeral 3200 in FIG. 3B and operation 6 in FIG. 2. In alternative embodiments only the correlation data and an associated message identifier is provided to recipient workspace application 140. In this case, recipient workspace application 140 can associate the correlation data with the message received from one of communication applications 200 using the message identifier. In either case, notification host 144 examines the received correlation data to determine whether the message is related to the recipient's current activity. See reference numeral 3210 in FIG. 3B. If so, notification host 144 pushes a new message notification to recipient 14. See reference numeral 3142 in FIG. 3A and operation 7a in FIG. 2. This allows recipient 14 to be promptly notified of incoming messages that are evaluated as being related to his/her current activity.

On the other hand, for messages that are considered to be unrelated to the recipient's current activity, notification can be withheld until the recipient is evaluated to be idle or relatively idle. To this end, recipient workspace application 140 includes idle detection module 146 which is configured to identify an appropriate time for notifying recipient 14 of a message evaluated to be unrelated to the recipient's current activity. More specifically, idle detection module 146 is configured to query and retrieve data characterizing the recipient's current activity. See reference numeral 3220 in FIG. 3B and operation 7b in FIG. 2. For example, idle detection module 146 can be configured to detect user interaction with resources 300 using an appropriate API. More specifically, an API can be configured to detect activity such as webcam status, microphone status, keyboard inputs, and mouse inputs. Other indications of user activity can be used in other implementations. Data characterizing the recipient's current activity can be acquired from a computing device associated with recipient 14, one or more resources 300 used by recipient 14, and/or a resource activity feed provided by recipient workspace application 140 and/or cloud computing environment 100. Based on the detected activity, a maximum delay threshold, and/or other considerations, idle detection module 146 eventually determines that a new message notification should be pushed to recipient 14. See reference numeral 3240 in FIG. 3B. In response, notification host 144 pushes a new message notification to recipient 14. See reference numeral 3142 in FIG. 3A and operation 7a in FIG. 2.

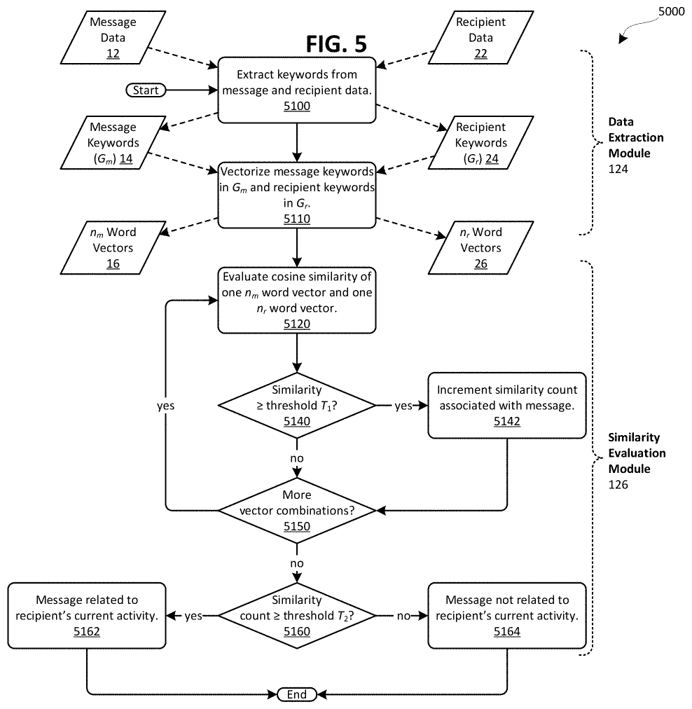

FIG. 6 is a flowchart illustrating an example method 6000 for determining when notification of a message that is not related to recipient's current activity should be pushed to recipient 14. In one implementation, method 6000 can be understood as providing a fine-grained idle detection framework that is implemented in a hybrid manner, that is, in at least a first stage and a second stage. More specifically, a maximum delay time can be divided into a first stage and a second stage, with different delivery standards established in each stage. Method 6000 starts with idle detection module 146 recording a start time at which analysis of recipient's activity begins. See reference numeral 6100 in FIG. 6. Idle detection module 146 also optionally begins generating a record of the number of observed user interface APM associated with recipient 14. Additional details with respect to recording the recipient's APM will be described in turn.

A determination is then made with respect to whether the time elapsed since the recoded start time exceeds an initial stage threshold T₃. See reference numeral 6110 in FIG. 6. In one implementation the initial stage threshold T₃=30 minutes, although other values for T₃ can be used in other implementations, such as T₃=10 minutes, T₃=15 minutes, T₃=20 minutes, T₃=45 minutes, T₃=60 minutes, or T₃ equals any other suitable value. The initial stage threshold T₃ can be adjustable by one or more of an administrator, message sender 12, or message recipient 14. In other implementations the initial stage threshold T₃ is hardcoded and/or provisioned by default.

If the time elapsed since the recorded start time does not exceed the initial stage threshold T₃, idle detection module 146 determines whether recipient 14 is using a webcam and/or a microphone. See reference numeral 6120 in FIG. 6. If so, recipient 14 is designated as busy. See reference numeral 6122 in FIG. 6. The time elapsed since the recorded start time can again be compared to the initial stage threshold T₃. In certain implementations both webcam and microphone activity are considered at this stage, while in other implementations only webcam or only microphone activity is considered at this stage.

On the other hand, if recipient 14 is not using a webcam or microphone, then idle detection module 146 determines whether recipient 14 has been observed to have provided input within an input time threshold T₄. See reference number 6140 in FIG. 6. In certain embodiments recipient 14 is considered to have provided input when keyboard or pointer (for example, mouse, touchpad, or touchscreen) activity is detected. In alternative implementations only keyboard or only pointer activity is considered at this stage. In one embodiment the input time threshold T₄=60 seconds, although other values for T₄ can be used in other implementations, such as T₄=20 seconds, T₄=30 seconds, T₄=45 seconds, T₄=90 seconds, T₄=120 seconds, T₄=180 seconds, or T₄ equals any other suitable value. The input time threshold T₄ can be adjustable by one or more of an administrator, message sender 12, or message recipient 14. In other implementations the input time threshold T₄ is hardcoded and/or provisioned by default.

If recipient 14 is observed to have been inactive for less than input time threshold T₄, recipient 14 is designated as busy. See reference numeral 6122 in FIG. 6. The time elapsed since the recorded start time can again be compared to the initial stage threshold T₃. On the other hand, if recipient 14 is observed to have been inactive for greater than or equal to input time threshold T₄, idle detection module 146 designates recipient 14 as idle. See reference numeral 6150 in FIG. 6. This indicates an appropriate time to notify recipient 14 of an incoming message that was previously evaluated as being unrelated to the recipient's current activity. In particular, this indicates that pushing such a notification to recipient 14 is less likely to cause recipient 14 to incur distracted time, and/or is more likely to be delivered at a time when recipient can devote his/her attention to the incoming message.

In some cases recipient 14 may be actively engaged in webcam, microphone, and/or input activity for a time period greater than initial stage threshold T₃. In this case, idle detection module 146 is configured to determine a minimum action per unit time (APMₘᵢₙ) value for recipient 14 during the period spanning the initial stage threshold T₃. See reference numeral 6160 in FIG. 6. The recipient's APM is a measure of the number of user interface actions which are observed per minute. In alternative implementations a different unit of time can be used to measure APM, such that APM can be understood more generally as being a measure of actions per unit of time (or, more concisely, “actions per time”). Example user interface actions which are considered in this regard include one or more of keystrokes, pointer inputs (for example, taps on a touchscreen, taps on a touchpad, or mouse clicks), pointer movements (for example, swipe gestures made on a touchscreen, swipe gestures made on a touchpad, or mouse movements), and audio inputs provided via a microphone. In an example implementation idle detection module 146 can be configured to detect the recipient's APM using an appropriate API configured to count observed user interface actions. In addition to APMₘᵢₙ during the period spanning T₃, idle detection module 146 can also be configured to determine a current APM value APM_{cur}. See reference numeral 6162 in FIG. 6.

A determination can then be made with respect to whether APM_{cur} is less than or equal to APMₘᵢₙ. See reference numeral 6170 in FIG. 6. If so, then recipient 14 is considered to be relatively idle, at least compared to his/her activity level during the period spanning T₃, and idle detection module 146 designates recipient 14 as idle. See reference numeral 6172 in FIG. 6. This indicates an appropriate time to notify recipient 14 of an incoming message that was previously evaluated as being unrelated to the recipient's current activity. If multiple notifications are being deferred, then multiple notifications can be pushed to recipient 14 when APM_{cur} becomes less than or equal to APMₘᵢₙ. On the other hand, if APM_{cur} is not less than or equal to APMₘᵢₙ, then recipient 14 is designated as still being busy. See reference numeral 6180 in FIG. 6.

If recipient 14 is still designated as being busy after initial stage threshold T₃ has elapsed and after APM_{cur} and APMₘᵢₙ have been compared, a determination is made with respect to whether the time elapsed since the recoded start time exceeds a subsequent stage threshold T₅. See reference numeral 6190 in FIG. 6. In one implementation the subsequent stage threshold T₅=60 minutes, although other values for T₅ can be used in other implementations, such as T₅=20 minutes, T₅=30 minutes, T₅=40 minutes, T₅=90 minutes, T₅=120 minutes, or T₅ equals any other suitable value. In one implementation, T₅=2×T₃, such that the initial stage during which webcam, microphone, and/or input activity is considered is of equal duration as the subsequent stage during which APM values are considered. In another implementation, T₅≥2×T₃, for example where T₃ is twenty-nine minutes and T₅ is sixty minutes. In still another implementation, the subsequent stage threshold T₅ is set to sixty minutes or another time corresponding to a frequently used meeting duration in a given organization. The subsequent stage threshold T₅ can be adjustable by one or more of an administrator, message sender 12, or message recipient 14. In other implementations the subsequent stage threshold T₅ is hardcoded and/or provisioned by default.

If the time elapsed since the recorded start time does not exceed the subsequent stage threshold T₅, idle detection module 146 redetermines APM_{cur}. See reference numeral 6162 in FIG. 6. On the other hand, if the time elapsed since the recorded start time equals or exceeds the subsequent stage threshold T₅, idle detection module 146 determines that a maximum notification delay has been reached. See reference numeral 6192 in FIG. 6. The maximum notification delay, that is T₅, reflects a maximum acceptable delay for notifying recipient 14 of an incoming message, regardless of the recipient's current activity. More specifically, this reflects a judgment that notification of incoming messages should not be delayed indefinitely in the case of a recipient who is perpetually evaluated as being busy.

In cases where subsequent stage threshold T₅ is a relatively long period of time, the recipient's current activity is optionally periodically reevaluated. This can be accomplished by, for example, advancing operations from reference numeral 6190 in FIG. 6 to reference numeral 5100 in FIG. 5. This allows a notification that had previously been deferred to instead be pushed later if recipient 14 becomes occupied with a new activity that is semantically relevant to the message.

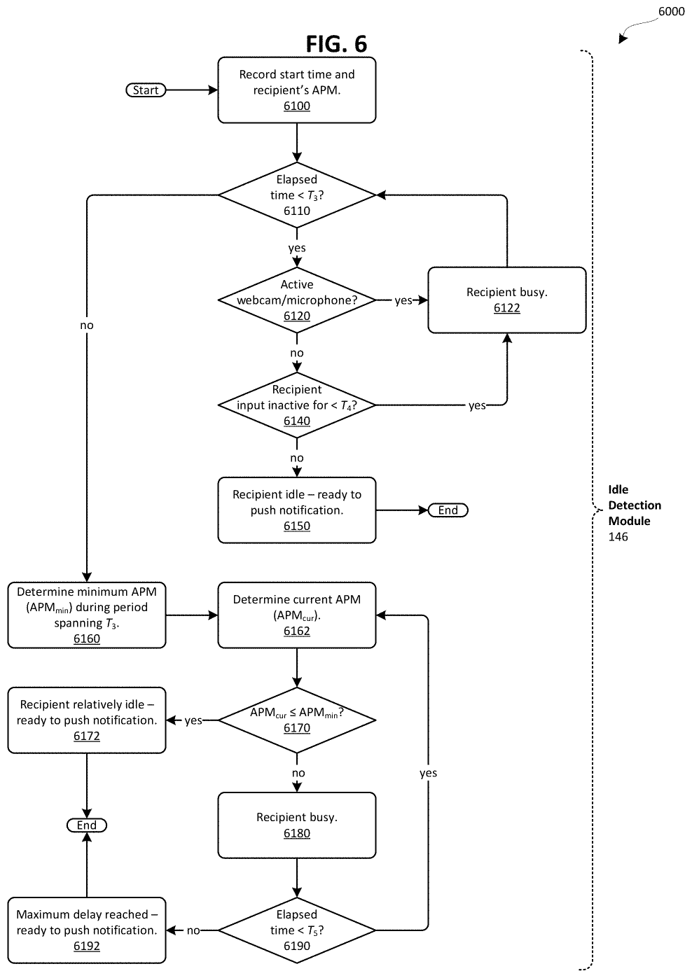

The evaluation of recipient's activity before and after initial stage threshold T₃ is illustrated in FIG. 7. In particular, FIG. 7 is a line graph illustrating an example recipient's APM (on the ordinate) as a function of time (on the abscissa), wherein initial stage threshold T₃ is 30 minutes. In this example, recipient 14 is evaluated to be busy from the time the message was received (t=0 minutes) until initial stage threshold T₃ (t=30 minutes). For instance, recipient 14 may have been actively using a webcam, a microphone, a keyboard, and/or a pointing device during this time. Once initial stage threshold T₃=30 minutes is reached, idle detection module 146 determines APMₘᵢₙ for the period spanning the initial stage threshold T₃. The determined APMₘᵢₙ is represented by the horizontal broken line in FIG. 7. As time progresses, idle detection module continues to evaluate a current APM value APM_{cur}. Initially, at t=30 minutes and shortly thereafter, APM_{cur} is greater than or equal to APMₘᵢₙ. Recipient 14 is not notified of the incoming message during this time. However, eventually APM_{cur} falls below APMₘᵢₙ, at which point recipient 14 is notified of the incoming message. If APM_{cur} does not fall below APMₘᵢₙ before subsequent stage threshold T₅ (not illustrated in FIG. 7) is reached, recipient 14 is notified of the incoming message once subsequent stage threshold T₅ is reached, which represents a maximum acceptable notification delay.

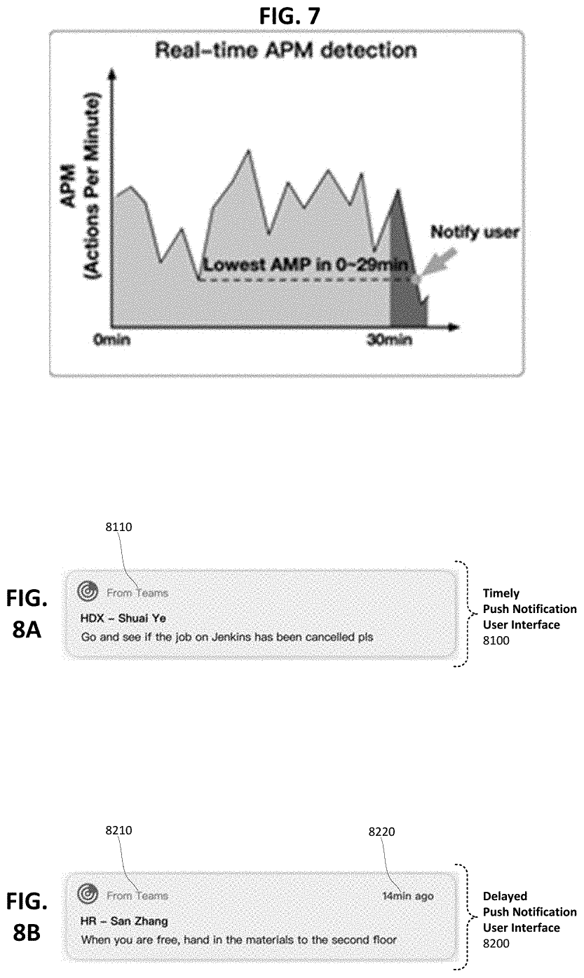

In certain implementations the appearance of the push notification provided to recipient 14 varies depending on whether the push notification was delivered pursuant to the aforementioned “instant notification” framework or the “automatic notification” framework. FIG. 8A illustrates an example timely push notification user interface 8100. Timely push notification user interface 8100 includes an originating application indicator 8110 that identifies which communication application 200 caused the notification to be generated. Because timely push notification user interface 8100 is displayed upon receipt of the incoming message, it does not initially display a receipt time. The notification displayed in timely push notification user interface 8100 may be referred to as a “timely”, “instant”, or “immediate” notification, which reflects the fact that it is delivered to recipient 14 without introducing any intentional delay.

FIG. 8B, on the other hand, illustrates an example delayed push notification user interface 8200. Delayed push notification user interface 8200 also includes an originating application indicator 8210 that identifies which communication application 200 caused the notification to be generated. But delayed push notification user interface 8200 also includes a time indicator 8220 that provides recipient 14 with an indication of when the message which caused the push notification was received. In certain implementations, delayed notifications are made available to recipient 14 in a message center administered by recipient workspace application 140, thus allowing recipient 14 to access such messages if he/she takes the initiative to do so. The notification displayed in delayed push notification user interface 8200 may be referred to as a “delayed” or “postponed” notification, which reflects the fact that it was intentionally delayed until a time that recipient 14 was perceived to be idle or relatively idle, or until a maximum delay time is achieved.

### Computing Devices for Asynchronous Message Notification Framework

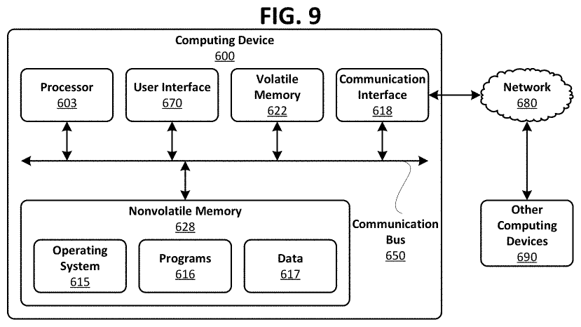

FIG. 9 is a block diagram schematically illustrating an example computing device 600 configured to implement various components of the systems disclosed herein. Computing device 600 includes a processor 603, volatile memory 622 (for example, random access memory (RAM)), nonvolatile memory 628 (also referred to as non-transitory memory), a user interface 670, a network or communication interface 618, and a communication bus 650. Computing device 600 may also be referred to as a client device, endpoint device, server device, computer, or computer system. Computing device 600 may be used to implement, for example, various components of cloud computing environment 100, including sender workspace application 110, analysis service 120, recipient workspace application 140, one or more communication applications 200, and/or one or more resources 300. In particular, computing device 600 is shown merely as an example client device or server device and can be implemented within any suitable computing or processing environment with any suitable type of physical or virtual machine or set of physical and virtual machines that can have suitable hardware and/or software capable of operating as described herein.

Nonvolatile memory 628 can include one or more hard disk drives or other magnetic or optical storage media. Nonvolatile memory 628 can additionally or alternatively include one or more solid state drives, such as a flash drive or other solid-state storage media. Nonvolatile memory 628 can additionally or alternatively include one or more hybrid magnetic and solid-state drives. Nonvolatile memory 628 can additionally or alternatively include one or more virtual storage volumes, such as a cloud storage, or a combination of such physical storage volumes and virtual storage volumes or arrays thereof.

User interface 670 can include a graphical user interface, examples of which include controls presented on a touchscreen, a display, or the like. User interface 670 can additionally or alternatively include one or more input/output devices, examples of which include a mouse, a keyboard, a microphone, one or more speakers, one or more cameras, one or more biometric scanners, one or more environmental sensors, one or more accelerometers, one or more visors, and the like.

Nonvolatile memory 628 stores an operating system 615, one or more applications or programs 616, and data 617. Operating system 615 and programs 616 include sequences of instructions that are encoded for execution by processor 603. Execution of these instructions results in manipulated data. Prior to their execution, the instructions can be copied to volatile memory 622. In some examples, volatile memory 622 can include one or more types of RAM and/or a cache memory that can offer a faster response time than a main memory. Data 617 can be entered through user interface 670 or received from the input/output devices such as communication interface 618. The various elements of computing device 600 described above can communicate with one another via communication bus 650.

Processor 603 can be implemented by one or more programmable processors to execute one or more executable instructions, such as a computer program, to perform functionality disclosed herein. The term “processor” describes circuitry that performs a function, an operation, or a sequence of operations. The function, operation, or sequence of operations can be hard coded into the circuitry or soft coded by way of instructions held in a memory device and executed by the circuitry. Processor 603 can perform the function, operation, or sequence of operations using digital values and/or using analog signals. In some examples, processor 603 can be embodied in one or more application specific integrated circuits, microprocessors, digital signal processors, graphics processing units, microcontrollers, field programmable gate arrays, programmable logic arrays, multicore processors, or general-purpose computers with associated memory. Processor 603 can be analog, digital, or mixed. In some examples, processor 603 can be one or more local physical processors or one or more remotely-located physical processors. A processor including multiple processor cores and/or multiple processors can provide functionality for parallel, simultaneous execution of instructions or for parallel, simultaneous execution of one instruction on more than one piece of data.

Communication interface 618 can include one or more interfaces to enable computing device 600 to access a computer network 680 such as a local area network, a wide area network, a personal area network, or the Internet through a variety of wired and/or wireless connections, including cellular connections and Bluetooth connections. In some examples, network 680 may allow for communication with other computing devices 690 to enable distributed computing. Examples of other computing devices 690 include devices used by message sender 12 and/or message recipient 14. Network 680 can include, for example, one or more private and/or public networks over which computing devices can exchange data.

In described examples, computing device 600 can execute an application on behalf of a user of a client device. For example, computing device 600 can execute one or more virtual machines managed by a hypervisor. Each virtual machine can provide an execution session within which applications execute on behalf of a user or a client device, such as a hosted desktop session. Computing device 600 can also execute a terminal services session to provide a hosted desktop environment. Computing device 600 can provide access to a remote computing environment including one or more applications, one or more desktop applications, and one or more desktop sessions in which one or more applications can execute.

### CONCLUSION

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims. In addition, the phraseology and terminology used herein is for the purpose of description and should not be regarded as limiting. Any references to examples, components, elements, or acts of the systems and methods herein referred to in the singular can also embrace examples including a plurality. Likewise, any references in plural to any example, component, element, or act herein can also embrace examples including only a singularity. References in the singular or plural form are not intended to limit the presently disclosed systems or methods, their components, acts, or elements. The use herein of “including”, “comprising”, “having”, “containing”, “involving”, and variations thereof is meant to encompass the items listed thereafter and equivalents thereof as well as additional items. References to “or” can be construed as inclusive so that any terms described using “or” can indicate any of a single, more than one, and all of the described terms.

What is claimed is:

1. A method of pushing a message notification to a message recipient, the method comprising:
capturing a message that is sent to a message recipient;
extracting a first set of one or more message keywords from the message;
extracting a second set of one or more recipient keywords from one or more digital resources associated with the message recipient;
evaluating a correspondence between the first set and the second set; and
pushing, to the message recipient, at a notification time, a notification of the message, wherein the notification time depends on the evaluated correspondence.

2. The method of claim 1, wherein the correspondence is evaluated as a binary parameter that is selected from (a) a first value indicating that the message has greater than a threshold semantic similarity to the one or more digital resources, or (b) a second value indicating that the message has less than the threshold semantic similarity to the one or more digital resources.

3. The method of claim 2, wherein the notification is pushed to the message recipient upon evaluating the correspondence as the first value.

4. The method of claim 2, wherein the notification is pushed to the message recipient upon (a) evaluating the correspondence as the second value and (b) determining that the message recipient is in an idle state.

5. The method of claim 2, wherein the notification is pushed to the message recipient upon (a) evaluating the correspondence as the second value and (b) determining that a maximum delay threshold has been reached.

6. The method of claim 1, wherein evaluating the correspondence further comprises:
generating a message vector representation of each of at least some of the one or more message keywords;
generating a recipient vector representation of each of at least some of the one or more recipient keywords; and
counting message vector representations that are similar to at least one of the recipient vector representations, wherein two vector representations are considered to be similar if they have a cosine similarity that exceeds a threshold.

7. The method of claim 1, wherein the one or more digital resources associated with the message recipient are digital resources accessed by the message recipient in a time period before the message was sent to the message recipient.

8. The method of claim 1, wherein the one or more digital resources associated with the message recipient are digital resources accessed by the message recipient within twenty-four hours of when the message was sent to the message recipient.

9. The method of claim 1, further comprising:
generating a first vector that represents a particular one of the message keywords; and
generating a second vector that represents a particular one of the recipient keywords;
wherein evaluating the correspondence includes evaluating a similarity between the first and second vectors.

10. The method of claim 1, further comprising receiving a message notification preference from a sender of the message, wherein the correspondence is evaluated in response to the message notification preference indicating that immediate notification of the message to the message recipient is optional.

11. A computer system that comprises a memory and at least one processor coupled to the memory, the at least one processor configured to:
capture a message that is sent to a message recipient;
extract a first set of one or more message keywords from the message;
extract a second set of one or more recipient keywords from one or more digital resources associated with the message recipient;
evaluate a correspondence between the first set and the second set;
in response to making a first determination that the correspondence indicates that the message has greater than a threshold semantic similarity to the one or more digital resources, push a timely notification of the message to the message recipient; and
in response to making a second determination that the correspondence indicates that the message has less than the threshold semantic similarity to the one or more digital resources, push a delayed notification of the message to the message recipient.

12. The computer system of claim 11, wherein the processor is further configured to, in response to making the second determination:
determine a minimum actions per time parameter APMₘᵢₙ associated with the message recipient during a first time period after the message recipient receives the message;
determine, at a time after the first time period has elapsed, a current actions per time parameter APM_{cur} for the message recipient; and
push the delayed notification to the message recipient in response to either (a) APM_{cur} being less than or equal to APMₘᵢₙ, or (b) a maximum delay threshold being exceeded.

13. The computer system of claim 11, wherein the processor is further configured to, in response to making the second determination:
make a third determination that (a) the message recipient has an inactive webcam, (b) the message recipient has an inactive microphone, and (c) the message recipient has not provided keyboard input during an input time threshold; and
push the delayed notification to the message recipient after making the third determination.

14. The computer system of claim 11, wherein the processor is further configured to, in response to making the second determination:
make a third determination that the message recipient is in an idle state; and
push the delayed notification to the message recipient after making the third determination.

15. The computer system of claim 11, wherein the processor is further configured to, in response to making the second determination:
make a third determination that a maximum delay threshold has been reached; and
push the delayed notification to the recipient after making the third determination.

16. The computer system of claim 11, wherein the delayed notification indicates a time at which the message recipient received the message.

17. A non-transitory computer readable medium storing processor-executable instructions to push a message notification to a message recipient, the processor-executable instructions comprising instructions to:
determine, for a recipient of a message, a minimum actions per time parameter APMₘᵢₙ associated with the recipient during a first time period after the recipient receives the message;
determine, at a time after the first time period has elapsed, a current actions per time parameter APM_{cur} for the recipient; and
push a notification of the message to the recipient in response to either (a) APM_{cur} being less than or equal to APMₘᵢₙ, or (b) a maximum delay threshold being exceeded, the maximum delay threshold being measured from when the recipient receives the message.

18. The non-transitory computer readable medium of claim 17, wherein the maximum delay threshold is greater than or equal to two times the first time period.

19. The non-transitory computer readable medium of claim 17, wherein the APMₘᵢₙ and APM_{cur} parameters are measured by counting how many actions the recipient takes per unit of time, wherein the actions include one or more of keyboard inputs and pointing inputs.

20. The non-transitory computer readable medium of claim 17, the processor-executable instructions further comprising instructions to determine that the recipient, during an entirety of the first time period, was performing at least one of:
using a webcam;
using a microphone; or
using an input device without letting the input device remain idle for more than an input time threshold.
